(19) United States
(12) Patent Application Publication
(10) Pub. No.: US 2012/0005517 A1
(43) Pub. Date: Jan. 5, 2012

(54) SYNCHRONISATION AND TIMING METHOD AND APPARATUS

(76) Inventors: Peter Graham Foster, South Australia (AU); Sergey Shandar, South Australia (AU); Alex Kouznetsov, South Australia (AU)

(21) Appl. No.: 13/060,181

(22) PCT Filed: Aug. 21, 2009
(86) PCT No.: PCT/AU09/01081

§ 371 Date: Sep. 16, 2011

Related U.S. Application Data
(60) Provisional application No. 61/090,638, filed on Aug. 21, 2008.

(51) Int. Cl. G06F 1/08

(52) U.S. Cl. 713/500

(57) ABSTRACT

A method and system for synchronising a first device and at least one second device, each having a local oscillator and a microcontroller, and the second device being in data communication with the first device via a communication bus. The method comprises the first device transmitting a plurality of signals to the second device, the second device using the plurality of signals to measure the frequency of its local oscillator, the first device transmitting a signal to the second device indicative of a required frequency to be synchronised to, and the second device employing its microcontroller to configure itself to generate a local clock signal with the required frequency using the frequency of its local oscillator.

### RELATED APPLICATION

This application is based on and claims the benefit of the filing date of U.S. application no. 61/090,638 filed 21 Aug. 2008, the content of which as filed is incorporated herein by reference in its entirety.

### FIELD OF THE INVENTION

The present invention relates to a method and apparatus for providing a microcontroller based synchronization and timing system, of particular but by no means exclusive use in providing syntonised clocks, data acquisition and automation and control of test and measurement equipment, instrumentation interfaces and process control equipment, and synchronization of such clocks to an essentially arbitrary degree in either a local or distributed environment.

### BACKGROUND OF THE INVENTION

The USB specification is intended to facilitate the interoperation of devices from different vendors in an open architecture. USB data is encoded using differential signalling, that is, in the form of the difference between the signal levels of two wires that transfer the information. The USB specification is intended as an enhancement to the PC architecture, spanning portable, desktop and home environments.

The USB specification assumes that devices differ. This is true for the intended environments in which devices from a multiplicity of manufacturers are connected, but there exist other environments (such as certain common industrial or laboratory environments) that require a specification for operating multiple devices of a similar nature in a synchronized manner. The specification does not sufficiently address this issue. Such environments are typically those where testing, measuring or monitoring is performed, and which require the devices to be synchronized to a more accurate degree than is specified. The USB specification allows limited inter-device synchronization by providing a 1 kHz clock signal to all devices. However, many laboratory and industrial environments require synchronization at megahertz frequencies and higher.

USB employs a tiered star topology, where hubs provide attachment points for USB devices. The USB host controller which is located on the user's personal computer (PC), laptop or personal digital assistant (PDA) contains the root hub, which is the origin of all USB ports in the system. The root hub provides a number of USB ports to which USB functional devices or additional hubs may be attached.

In turn, one can attach more hubs (such as USB composite devices) to any of these ports, which then provide additional attachment points via ports for further USB devices. In this way, USB allows a maximum of 127 devices (including hubs) to be connected, with the restriction that any device may be at most five levels deep.

The root hub in the host transmits a Start of Frame (SOF) signal packet every 1 ms to every device, the time between two SOF packets being termed a frame. Each module receives this SOF packet at a different time, owing to electrical delays inherent in the USB topology, which means that there may be a significant time delay (specified as≦380 ns) between the receipt of a signal at a device connected directly to the host controller and at a device that is five levels down. This is a severe restriction when it is desired to synchronize devices at megahertz levels and above. Furthermore the USB specification allows the host controller to fail to transmit up to five consecutive SOF tokens.

Current synchronization between a USB host and a USB device is possible by two types of USB transfers, Interrupt and Isochronous. Interrupt transfers allow guaranteed polling frequencies of devices with minimum periods of 125 μs, whereas isochronous transfers guarantee a constant transfer rate. Both methods require there to be traffic between the device and host for synchronization to take place and therefore reserve more bandwidth for higher degrees of synchronization. This unfortunately means that the available USB bandwidth can be used up before the maximum number of devices has been connected. This approach also places on the host the great computational burden of keeping 127 devices synchronized to the host by means of software, yet still fails to address maintaining synchrony between the devices as to the host the individual devices represent separate processes.

Devices that contain a physical transducer of some kind, such as a laser diode or a photodetector, may require clock and trigger information. A device such as a laser diode with a modulated light output at 1 MHz may use a clock signal to perform transducer functions at regular intervals or at a constant frequency. A trigger signal is usually used to start or end an operation at a set time. In the laser diode example, a trigger signal could be used to turn the modulated light output on or off.

These clock and trigger signals can be used to synchronize a multiplicity of devices to each other (and hence constitute what is referred to below as “synchronization information”), provided that the signals are common and simultaneous to all devices. ‘Common’ and ‘simultaneous’ here mean that the variation in time of these signals between the devices is less than a specified quantity, δt. In the laser diode example, this would enable a multiplicity of laser diodes to modulate their light output at one frequency. The modulation frequency of all devices would be the same, and their waveforms would be in-phase. The current USB specification (viz. 2.0) allows for a δt of up to 0.35 μs. For a signal with a frequency of 1 MHz and a period of 1.0 μs, this delay represents almost half of the period. It is thus unusable as synchronization information for routine use.

Devices such as hubs and USB controller chips commonly use some amount of endpoint phase locking in order to decode the USB protocol. It is the purpose of the SYNC pattern in the USB protocol to provide a synchronization pattern for another electronic circuit to lock to. However, this is intended to synchronize the device endpoint to the USB bit streams to an accuracy sufficient to interpret data streams. It is not intended to synchronize the functionality of two separate devices to each other. In particular it is not intended to synchronise device functionality to the level required by many test and measurement instruments.

The USB specification—to the extent that it deals with inter-device synchronization—is mainly concerned with synchronizing the data packets of a USB-CD audio stream sufficiently for output on a USB-speaker pair. The requirements of such an arrangement are in the kHz range and, for this application, the USB specification allows implementation of an isochronous pipe in which data loss is tolerated. However, the specification does not address the potential problems of synchronizing, for example, 100 USB-speaker pairs as the present means merely synchronises pairs of endpoints rather than the functionality of the device. Nor does it address issues related to data loss which are unacceptable in the vast majority of applications.

As discussed above, USB communication transfers data during regular 1 ms frames (or, in the case of the High-Speed USB specification, in eight micro-frames per 1 ms frame). A Start of Frame (SOF) packet is transmitted to all but Low-Speed devices at the beginning of each frame and to all High-Speed devices at the beginning of each micro-frame. The SOF packet therefore represents a periodic low resolution signal broadcast to all but Low-Speed devices connected to a given Host Controller.

This SOF packet broadcast occurs at a nominal frequency of 1 kHz (or, in the case of the High-Speed USB specification, 8 kHz). However the USB specification allows a very large frequency tolerance (by instrumentation standards) of 500 parts per million. The background art utilises this low resolution frequency signal that is broadcast to each of the devices to provide clock synchronization, but only to the somewhat ambiguous frequency provided by the USB Host Controller.

U.S. Pat. No. 6,343,364 (Leydier et al.) discloses an example of frequency locking to USB traffic, which is directed toward a smart card reader. This document teaches a local, free-running clock that is compared to USB SYNC and packet ID streams; its period is updated to match this frequency, resulting in a local clock with a nominal frequency of 1.5 MHz. This provides a degree of synchronization sufficient to read smart card information into a host PC but, as this approach is directed to a smart card reader, inter-device synchronization is not addressed.

U.S. Pat. No. 6,012,115 and subsequent continuation U.S. Pat. No. 6,226,701 (Chambers et al.) address the USB SOF periodicity and numbering for timing. These documents disclose a computer system that can perform an accurate determination of the moment in time a predetermined event occurred within a real-time peripheral device by using the start of frame pulse transmitted from a USB host controller to peripheral devices connected to it.

U.S. Pat. No. 6,092,210 (Larky et al.) discloses a method for connecting two USB hosts for the purpose of data transfer, by employing a USB-to-USB connecting device for synchronizing local device clocks to the data streams of both USB hosts. Phase locked loops are used to synchronize local clocks and over-sampling is used to ensure that data loss does not occur. This document, however, relates to the synchronization of the data streams of two USB hosts with each other (and with limited accuracy) such that transfer of information is then possible between said Hosts; no method for synchronizing a plurality of USB devices to a single USB Host or to a plurality of USB hosts is provided.

U.S. Pat. No. 5,761,537 (Sturges et al.) describes how to synchronize two or more pairs of speakers with individual clocks, where one pair operates off a stereo audio circuit in the PC and the other pair is controlled by the USB. Both speaker pairs use their own clocks, so they need to be synchronized so this document teaches one technique for maintaining synchronization of the audio signals despite possible clock skew between the asynchronous clocks.

U.S. patent application Ser. No. 10/620,769 (Foster et al.) discloses a synchronized version of the USB, in which the local clock of each device is synchronized on a given USB to an arbitrary degree. This document also discloses a method and apparatus for providing a trigger signal to each device within the USB such that an event may be synchronously initiated on multiple devices by the trigger signal.

This architecture for synchronization of the local clock on each of a plurality of USB devices employs periodic data structures already present in the USB traffic. An embodiment disclosed in U.S. application Ser. No. 10/620,769 essentially locks the local clock in frequency and phase to the detection of a SOF packet token at the USB device. Circuitry is employed to observe traffic through the USB and decode a clock carrier signal from bus traffic (in one embodiment, SOF packets), which results in a nominal carrier signal frequency of 1 kHz (or 8 kHz for USB High Speed). The local clock signal from a controlled oscillator clock is locked to the reception of the USB SOF packet in both phase and frequency. This ensures that all devices attached to the root hub are locked in frequency to the point at which they receive the SOF packet token. However, this approach is limited in its ability to provide a precisely known clock frequency to each device.

Further, although this disclosure teaches the highly accurate clock synchronization of devices attached to a USB, the disclosed approach employs a precision controlled oscillator, typically in the form of a voltage controlled voltage oscillator, and particular care must be taken to provide stable supply voltages. A closed loop control circuit is then applied to the precision oscillator. This adds both cost and complexity to the design of a synchronized USB device.

Another synchronized USB device, disclosed in U.S. patent application Ser. No. 60/773,537 filed 15 Feb. 2007 (Foster et al.), allows the generation of accurate clock frequencies on board the USB device regardless of the accuracy of the clock in the Host PC. In this disclosure the USB Start of Frame packet is treated as a clock carrier rather than a reference signal to which the local clock is synchronised to. The carrier signal, once decoded from the USB traffic, is combined with a scaling factor to generate synchronization information and hence to synthesize a local clock signal with precise control of the clock frequency. In this way, the frequency of the local clock signal can be more accurate than the somewhat ambiguous frequency of the carrier signal.

This arrangement is said to be able to produce a local clock signal to arbitrarily high frequencies, such as a clock frequency of tens of megahertz, and thus to ensure that the local clock of each device connected to a given USB is synchronized in frequency. U.S. application Ser. No. 10/620,769 also teaches a method and apparatus to further synchronize multiple local clocks in phase by measurement of signal propagation time from the host to each device and provision of clock phase compensation on each of the USB devices.

While such synchronous USB systems can perform accurate clock synchronisation between USB devices with accurate clock frequency generation, they require special hardware components to decode data present on the USB and precision determination of the moment in time of carrier signal reception. These components are required in addition to the normal USB bus interface circuitry and microcontroller so these approaches are not compatible with a generic implementation of USB using off the shelf USB interface microcontrollers.

Additionally, the USB specification constraints the level of capacitance that the USB device can present to the bus. The effective capacitance of USB each data line to ground in the presence of the parallel effective resistance to ground is very tightly controlled. There is generally only a small capacitance margin with compliant USB devices. Addition of a parallel data pathway circuit to a conventional USB device would typically exceed the capacitance limits.

In contrast, International Patent Application No. PCT/AU2008/000663 (Foster) discloses a synchronized version of the USB, in which the local clock of each device is synchronized on a given USB using a software-based frame detection mechanism, using a single USB connection point via the microcontroller rather than the parallel data pathway employed in prior art but this comes at the expense of precision. This approach aims to simplify the control loop and obviate the need for a sensitive analogue phase locked loop architecture, but at the cost of synchronisation precision.

### SUMMARY OF THE INVENTION

In a first broad aspect, the invention provides a method of synchronising a first device and at least one second device (which may be one or a plurality of such second devices), each having a local oscillator (such as a free-running oscillator) and a microcontroller, and the second device being in data communication with the first device via a communication bus, the method comprising:
said first device transmitting a plurality of signals to said second device;
said second device using said plurality of signals to measure the frequency of its local oscillator;
said first device transmitting a signal to said second device indicative of a required frequency to be synchronised to; and
said second device employing its microcontroller to configure itself to generate a local clock signal with said required frequency using the frequency of its local oscillator.

The devices may be USB devices.

In one embodiment, the method includes the second device configuring itself to generate said local clock signal with said required frequency to an arbitrary degree.

Thus, in this embodiment microcontroller-based multi-device synchronisation is provided whereby the (at least one) second device, each with their own oscillator, are attached to a common bus and synchronised using signals from that bus. Typically, each device receives a common signal from the bus which is used as a reference carrier signal. The local clock of each device can be characterised by the common carrier signal using resources normally available in a microcontroller and thereby synchronised.

In some embodiments, such as where the communication bus is a USB, a system controller, such as a personal computer containing a USB host controller, receives information from each attached device about the frequency of its free running local clock. The system then provides each of the devices with information to synthesise their own synchronised clocks from the carrier signal and the local free running clock.

Statistical means may be used to process the information to provide greater synchronisation accuracy. Additional hardware support may be used by each of the devices to increase the resolution and accuracy of their clock synthesis.

The present invention is not limited in application to the USB or external busses, but may also find application in any general communication bus, such as PCI, PCI-e, Ethernet, Firewire. Similarly the present invention can be applied, for example, to wireless or fibre optic communication systems or busses between components on a printed wiring board or integrated silicon chip.

In certain embodiments, the plurality of signals comprise a plurality of periodic signals.

In a particular embodiment, the method includes the first device transmitting the plurality of signals at predefined times (such as at the one second boundary in local universal time).

The first device may be a master or controller device, wherein the second device is a slave device. The method may also comprise a peer to peer network of devices, such that the first device does not control the second device, but rather merely acts as the synchronisation signal source.

In one embodiment, the method includes the first device transmitting the plurality of signals to the second device in a non-periodic manner, with a time-stamp. The time-stamp may be from a time domain of a host system or a master time device.

The microcontroller may comprise a clock generator, such as a timer/counter.

In certain embodiments, the microcontroller is configured to execute an interrupt service routine upon detection of the plurality of signals.

The microcontroller may be provided in the form of a field programmable gate array logic device or other logic element.

Preferably the microcontroller comprises circuitry to measure the interval between receptions of synchronisation reference signals, such as in the form of a counter/timer (whether hardware, software or otherwise) clocked from said local oscillator. Preferably the microcontroller comprises circuitry to generate a local clock signal comprising a counter/timer or other clock generation circuitry clocked from the same local oscillator.

The counter/timer or other clock generation functionality may be contained within a field programmable gate array logic device or other logic element.

The communication bus may be a serial bus, a parallel bus or other form of communication bus, the first and second devices being of respective types attached to their respective bus. The communication bus may be a serial bus in the form of a Universal Serial Bus (USB), a PCI-Express bus, Ethernet, Firewire bus, RS232 or other serial interface bus. The communication bus may be a parallel bus in the form of a PCI bus, a PXI bus, a VME bus, a VXI bus, or a GPIB or other parallel interface bus. The communication bus may be located between devices on a wired, optical or wireless bus, a backplane bus for a rack-based instrument, a bus on a printed circuit board or an intra-chip bus.

The communication bus may comprise a single bus or a plurality of inter-connected busses, such as a hybrid interconnected bus comprising a plurality of different but connected busses (such as used in some electronic test equipment). According to this aspect, the first and (at least one) second devices may be attached to a plurality of different busses and all synchronised.

By way of example, USB devices, Ethernet devices and PCI devices may all be synchronised according to this aspect of the invention.

In one embodiment, the second device is one of a plurality of second devices in data communication with the first device via the communication bus, wherein the method comprises:
said first device transmitting the plurality of signals to the plurality of other devices;
each of the second devices using said plurality of signals to measure the frequency of its respective local oscillator;

said first device transmitting a signal to said second devices indicative of a required frequency to be synchronised to; and
said second devices employing their respective microcontrollers to configure themselves to generate respective local clock signals with said required frequency using the frequency of their respective local oscillators.

In a second broad aspect, the present invention provides an apparatus, comprising:
a USB device with a local clock, a microcontroller with counter/timer functionality and an oscillator (such as a free-running local oscillator), wherein the microcontroller is configured to respond to a predefined software interrupt (such as with an interrupt service routine provided therein) by generating an output signal adapted to be used as a synchronization reference signal for substantially all of a plurality of clock carrier signals, said USB device being attachable to a USB host controller;
circuitry configured to observe USB traffic, decode from a USB data stream a periodic signal transmitted by said host controller and comprising a clock carrier signal containing information about a distributed clock frequency and phase, and to output a decoded carrier signal;
circuitry configured to receive said decoded carrier signal, to generate said predefined software interrupt upon receipt of a predefined data packet (such as a SOF packet) and to pass the software interrupt to the microcontroller;
circuitry to measure the interval between receptions of said synchonisation reference signals (and hence carrier signals) in the time domain of said local oscillator, said measurement providing information about the frequency of said local oscillator with respect to the known carrier signal frequency (for example using a first counter/timer function);
wherein said apparatus is adapted to respond to a message from said USB host controller containing information about a required synchronisation frequency by calculating a setting for a second counter/timer circuitry based on said synchronisation frequency and said frequency of said local oscillator, said USB device setting the configuration of said counter/timer circuitry within said microcontroller to generate an output signal upon reaching a terminal count event in the case of a counter function or a timeout event in the case of a timer function;
wherein said second counter/timer is clocked by said oscillator (whose frequency has been characterised with reference to said periodic carrier signal); and
upon said second counter/timer reaching said terminal count or said timeout event resetting said configuration of said counter/timer.

Thus, according to this aspect, a method for generating a synchronised local clock on a device attached to a communication bus is provided that is suitable for using an inexpensive free running oscillator and the features available to a standard microcontroller.

Preferably the circuitry to measure the interval between receptions of said synchonisation reference signals is a first counter/timer function clocked from the local oscillator.

Preferably a second counter/timer circuitry is used to generate the synchronised clock signal. Preferably also the frequency of the local oscillator is continually measured with respect to said clock carrier signal and modifications to the configuration of said second counter/timer circuitry are continually made in order to maintain synchronisation of said local clock signal while the local oscillator drifts in frequency.

Preferably the interval used to measure the local oscillator's frequency is the interval between receptions of successive carrier signals. Preferably the accuracy of measurement of the local oscillator's frequency is increased by measurement over multiple successive intervals and using statistical means.

Preferably the microcontroller is a device containing timer/counter functionality. It will be understood by those skilled in the art that such counter/timers can be replicated externally to a microcontroller in logic devices, for example but not limited to Field Programmable Gate Arrays (FPGA) or Complex Programmable Logic Devices (CPLD).

Preferably the microcontroller comprises an interrupt service routine whereby said interrupt service routines can be called or triggered by detection of said carrier signals.

Preferably said interrupt is a hardware interrupt wherein there is minimal latency in generating the required output from Interrupt Service Routine (ISR).

Preferably also said second counter/timer circuitry is operable to generate a hardware output signal upon reaching terminal count or timeout wherein there is minimal latency in generating the required output signal.

Preferably said calculation of setting for said counter/timer circuitry is made in said USB device. Preferably also said calculation of setting for said counter/timer circuitry is alternatively made in said USB host controller.

It will be understood by those skilled in the art that the local oscillator may be free-running for economy, but may alternatively be in the form of—for example—a Voltage Controlled Crystal Oscillator (VCXO) (especially in phase locked loop (PLL) architectures), a Temperature Compensated Crystal Oscillator (TCXO), a Oven Controlled Crystal Oscillator (OCXO) or a multi-tap clock for increased accuracy.

It is also understood by those skilled in the art that said counter/timer circuitry may not be clocked directly from the local oscillator but from a clock source divided or multiplied in frequency from the local oscillator.

According to this aspect, the present invention provides a method of synchronising the local clock of a USB device having a microcontroller and a local oscillator (such as a free-running local oscillator) attached to a USB host controller, said microcontroller containing counter/timer functionality, the method comprising:
said host controller transmitting a periodic signal to said USB device, wherein said periodic signal constitutes a clock carrier signal;
observing USB traffic and decoding from a USB data stream said periodic signal containing information about a distributed clock frequency and phase and outputting a decoded carrier signal;
receiving said decoded carrier signal, generating a software interrupt upon receipt of a predefined data packet (such as a SOF packet) and passing the software interrupt to the USB microcontroller;
said USB microcontroller responding to the software interrupt (such as with an interrupt service routine provided therein) by generating an output signal adapted to be used as a synchronization reference signal for substantially all of said clock carrier signals;
measuring the interval between receptions of said synchonisation reference signals (and hence carrier signals) in the time domain of said local oscillator, to provide information about the frequency of said local oscillator with respect to the known carrier signal frequency (for example using a first counter/timer function);
said USB host controller transmitting a message to said USB device, said message containing information about the required synchronisation frequency;
calculating a setting for a second counter/timer circuitry using said synchronisation frequency and said frequency of said local oscillator;
said USB device setting the configuration of said counter/timer circuitry within said microcontroller to generate an output signal upon reaching a terminal count event in the case of a counter function or a timeout event in the case of a timer function;
wherein said second counter/timer is clocked by said local oscillator (whose frequency has been characterised with reference to said periodic carrier signal); and
upon said second counter/timer reaching said terminal count or said timeout event resetting said configuration of said counter/timer.

According to this aspect, a plurality of USB devices may be synchronised to an arbitrary degree, wherein said method is applied to synchronise a plurality of USB devices attached to a common USB host controller.

It will be understood by those skilled in the art that measurement of the period between receptions of successive carrier signals with respect to said local oscillator is equivalent to knowing the time of said plurality of receptions of carrier signals in the time domain of the local oscillator. It is also understood that such a relative notion of time can be referenced to an absolute notion of time.

In a third broad aspect, the invention provides a system for synchronising the local clock of a device to a bus derived timebase, comprising:
a measurement stage;
a prediction stage; and
a control stage.

Each of these stages effects a corresponding method (referred to below as the measurement, prediction and control methods respectively).

In a preferred embodiment said measurement stage comprises:
a first device having a microcontroller and local oscillator attached to a communication bus, said microcontroller containing a counter/timer clocked by a oscillator;
circuitry for monitoring said bus traffic, and circuitry for decoding from said bus a clock carrier signal generated by at least one of at least one second device attached to said bus wherein said carrier signal is a known frequency; and
wherein said measurement stage is configured to perform a plurality of measurements of the local time of said counter/timer circuitry upon receipt of a plurality of said carrier signals from said communication bus, each of said measurements corresponding to receipt of each of said plurality of carrier signals.

The counter/timer circuitry of a typical microcontroller generally has fewer than 16-bits of resolution, and often fewer than 12. This means that the counter/timer will rollover frequently when clocked by a high frequency oscillator. Thus, in one embodiment, the measurement stage is adapted to track the rollover events and convert the plurality of low bit-count timer measurements to a high resolution 64-bit or other representation of time.

In this way the measurement stage provides an array of measurements of the time of the plurality of carrier signals in the time domains of one or more second devices and 64-bit timer values corresponding to time in the time domain of the first device.

Preferably the carrier signals are periodic but need not be as the result of said measurement method is a map of carrier signal time versus local oscillator time.

The at least one second device may be a bus controller or host controller device or master bus device. The second device may also be a standard device in a peer-to-peer bus architecture.

Preferably the plurality of timing reference signals are periodic signals wherein the period and absolute time of said signals is known in the time domain of the second device. The plurality of timing reference signals may also be non-periodic but are each time-stamped in the time domain of the second device.

Preferably the measurement stage is adapted to operate continuously, wherein each of the measurements provides a new measure of the frequency of the oscillator in the second device over the most recent measurement period. As the number of measurements increases (or characterisation of said oscillator improves), the potential accuracy of said predictive method increases.

According to this aspect, the communication bus may be a serial bus, parallel bus or other form of communication bus, with the devices being of the type attached to their respective bus. If a serial bus, the communication bus may be a Universal Serial Bus (USB), a PCI-Express bus, an Ethernet, a Firewire bus, or an RS232 or other serial interface bus. If a parallel bus, the communication bus may be a PCI bus, a PXI bus, a VME bus, a VXI bus, or a GPIB or other parallel interface bus. The communication bus may be between devices on a wired, optical or wireless bus, a backplane bus for a rack-based instrument, a bus on a printed circuit board or even an intra-chip bus.

The communication bus may be a single bus or a plurality of interconnected busses. It is within the scope of this aspect that a plurality of devices attached to a plurality of different busses may all be synchronised. By way of example (but not limited to) USB devices, Ethernet devices and PCI devices may all be synchronised using this aspect of the invention.

In the case of a plurality of interconnected busses, the measurement stage may be applied to each interconnection of said busses and said devices attached thereto. In this way a map (array of interrelated measurements) of the relative clock rates of each of said attached bus and device would be built up over time.

Preferably the bus is a USB and the first device is a USB host controller, in which case the carrier signals may comprise any of the USB packet signal structures defined in the USB specification, command sequences sent to said USB device, data sequences sent to the USB device, OUT tokens, IN tokens, ACK tokens, NAK tokens, STALL tokens, PRE tokens, SOF tokens, SETUP tokens, DATA0 tokens, DATA1 tokens, or predefined bit pattern sequences in the USB data packets.

According to this aspect, the oscillator is characterised over a period of time with respect to the plurality of timing reference signals. In this way the drift in frequency of said oscillator can be precisely known over extended periods of time with respect to the time domain of said first device. By inference, if the timebase of said second device is know, then the frequency of said oscillator and hence timebase of said first device can be characterised absolutely.

As will be appreciated by those skilled in this art, there exist several algorithms for rate analysis and disciplining of clock signals. A useful disciplining algorithm is known as Kalman filtering in which the state of a generic system can be estimated from a series of measurements which contain random error (such as the discretisation errors in determination of said oscillator frequency). Using this approach the oscillator can be characterised over very long periods and with a high degree of accuracy, leading to accurate predictions of future frequency drift.

Preferably said prediction stage:
reads a data set corresponding to a plurality of time-stamped measurements in a plurality of time domains;
determines a relationship between the plurality of time domains; and
extrapolates said relationship forward in time.

Preferably the data set comprises the measurements. Preferably the prediction stage employs statistical calculation to improve the accuracy of determining the relationship.

Preferably the extrapolation comprises linear, polynomial or exponential extrapolation or a predictive approach based on Kalman filtering or similar statistical techniques.

Calculations performed by the prediction stage may be performed by the first device, in one of the at least one second devices or in another device in communication with first and second devices.

In this way the output of the prediction stage is a map of the plurality of time domains. This provides an estimate of the local time in each time domain at all times. In one embodiment described below there is a mapping between the reference time domain of at least one of said plurality of second devices and the time domain of the first device which is clocked from the local oscillator.

The data set may correspond to a plurality of interconnected busses. It is within the scope of this aspect that a plurality of devices attached to a plurality of different busses may all be synchronised. By way of example (but not limited to) USB devices, Ethernet devices and PCI devices may all be synchronised using this aspect of the invention.

In the case of a plurality of interconnected busses, said mapping and prediction of time applies to each of said plurality of busses and devices—across the breadth of said hybrid interconnected bus.

It is understood that the accuracy of said mapping decreases as time is extrapolated into the future.

Preferably the control stage is adapted to:
receive data indicative of a current time (t1) of said counter/timer of said first device from said measurement or prediction stage;
select a point in time (t2) at which a future event is to be generated;
control an output signal with a second counter/timer resource such that the output signal is generated at said time (t2) of said future event;
calculate the number of ticks (or “tick count”) of said second counter/timer required to generate said output signal at time t2 upon reaching a terminal count event in the case of a counter function or a timeout event in the case of a timer function;
configure said second counter/timer circuitry with said tick count to generate an output signal upon reaching said terminal count event in the case of a counter function or said timeout event in the case of a timer function;
wherein said second counter/timer is clocked by said oscillator (whose frequency has been characterised with reference to said periodic carrier signal) and is adapted to generate an output signal upon reaching said terminal count event or said timeout event.

The control stage may be adapted to generate a local clock signal. According to this embodiment, the control stage is adapted to:
generate an output signal at time t1;
generate an output signal at time t2 by loading said second counter/timer with a new tick count; and
reset said second counter/timer with said tick count configuration such that a next timeout or terminal count occurs at time t2+(t2−t1).

These steps may then be repeated by the control stage.

Preferably the measurement and prediction stages are also continuously employed so that drift in the frequency of the oscillator is measured and the predictive stage provides updated values of the tick count to maintain synchronicity of the local clock signal with reference clock of the second device.

In this way, the control stage is able to synthesise the local clock signal up to arbitrarily high frequencies given a sufficiently high operating frequency of the oscillator.

Preferably the frequency of the oscillator is substantially higher than the frequency of the periodic carrier signals. This allows high resolution in determination of said interval between said periodic carrier signals. Similarly, in the case of a non periodic but time-stamped carrier signal the period (inverse of frequency) of said oscillator is substantially smaller than said interval between receptions of carrier signals.

Preferably the frequency of the local clock signal is substantially lower than the frequency of the oscillator to allow a high resolution in controlling the local clock frequency. Additionally it is unlikely that the local clock period (i.e. the inverse of frequency) will be an exact multiple of the period of the oscillator, particularly as the local clock is controlled to some external frequency reference and said oscillator is expected to drift in frequency. In this case there will be some jitter in the period of the local clock of at least one oscillator period.

According to this aspect, various methods may be employed in order to provide finer control of the final synchronised clock signal. In one embodiment, said method of controlling the final output frequency of said local clock may involve adjustments to the rate at which said timer/counter is clocked. Furthermore, judicious choice of said ‘tick count’ during consecutive cycles of said local clock signal may be used to reduce the effects of clock frequency noise as frequency tuning occurs. For example, if an adjustment is required to be made to the local clock signal to account for drift in said local oscillator (which may be free-running) it is preferable to slowly adjust the local clock rate over a period of several cycles rather than use a step change. Such a method can significantly influence the frequency spectrum of the clock noise and potentially spread such control-loop noise over a wide frequency band (at low amplitude) rather that generate a large amplitude narrow frequency component into the noise spectrum. Other similar methods and applications of such methods will be readily apparent to those skilled in the art.

According to this aspect therefore methods are employed to dither the configuration of the second timer/counter around the nominal configuration required for setting the periodic frequency required for said local clock signal. This has the effect of reducing clock jitter. The control stage can then adjust how it manages the digital adjustment of phase (configuration of subsequent counter/timer periods) over the next interval while said system it is waiting for a updated synchronisation information.

The fundamental accuracy of such a control stage is limited by the measurement interval, the frequency of the oscillator and the drift in frequency of the oscillator. Increasing the measurement interval increases the potential resolution of measuring the oscillator frequency, however this also results in greater drift of the oscillator frequency during the interval. There is a trade-off between measurement accuracy and oscillator drift. A disciplined clock approach with a predictive system allows greater certainty in oscillator frequency over longer periods and hence greater precision.

The local oscillator is preferably a free-running local oscillator, but it will be understood by those skilled in the art that Voltage Controlled Crystal Oscillators (VCXO) (especially in a phase locked loop (PLL) architectures), Temperature Compensated Crystal Oscillators (TCXO), Oven Controlled Crystal Oscillators (OCXO) multi-tap clocks or other more accurate clock sources could also be used instead of a free-running local oscillator for increased accuracy.

It will also be understood by those skilled in the art that the counter/timer circuitry may be clocked, not directly from the local oscillator, but from a clock source either divided down or multiplied up frequency from the local oscillator.

Similarly, a phase adjustment may be made to the local oscillator signal before being used to clock the counter/timer circuitry in order to increase the resolution of event generation.

The synchronised local clock signal can then be used to generate a plurality of output signals and/or accurately timestamp external events or signals.

The communication bus can be a single bus or a plurality of inter-connected busses. It is within the scope of this aspect that a plurality of devices attached to a plurality of different busses may all be synchronised. By way of example (but not limited to) USB devices, Ethernet devices and PCI devices may all be synchronised using this aspect of the invention.

In the case of a plurality of busses, the control stage is preferably applied to each interconnection of busses and devices attached thereto.

These three stages of this aspect implement respective methods (measurement, prediction and control) that can—according to the present invention—be combined as described above or used separately as desired. They may also be used in conjunction with any of the other inventions taught in this disclosure.

According to this aspect, therefore, there is provided any one or more of the methods implemented by the three stages described above.

It is furthermore possible to synchronise data acquired by a plurality of devices by merely employing the measurement and calculation phases of this broad aspect.

According to this aspect, therefore, the present invention provides a method of synchronising data acquired by a plurality of devices attached to a communication bus, the method comprising:
determining a mapping between the unsynchronised time domains of said plurality of devices using any of the methods taught in this disclosure;
time stamping data acquired in the time domain of each respective device;
transmitting said time stamped data to a central location; and
time aligning said data from said plurality of devices.

In one embodiment, a plurality of USB devices attached to a USB each contain a free-running local oscillator, said respective free running local oscillators being used to control the acquisition of data at each of said respective USB devices. Said plurality of USB devices have their time domains mapped to the time domain of a USB host controller via the methods disclosed here. Data acquired by each of said USB devices is then time aligned in the host PC by the time stamps associated with each acquisition point.

It should be noted that although data is not sampled synchronously (at the same instant) by each USB device, it can be aligned on a common timebase. Furthermore this technique can be applied to a plurality of devices connected via a plurality of communication busses as will be further illustrated in a sixth broad aspect of the present invention.

According to a fourth broad aspect, the present invention provides a method for improving the accuracy of local clock phase synchronisation, the method comprising:
syntonising a local clock of a device attached to a communication bus;
decoding bus traffic of said communication bus for a predefined periodic carrier signal;
determining a phase of a local clock signal of said local clock at the instant of reception of each of said periodic carrier signals;
determining with statistical methods a true phase of said local clock signal with respect to said periodic carrier signals; and
adjusting the phase of said local clock such that said local clock is synchronised.

Preferably syntonising the local clock adapts the frequency of the local clock to be locked to the periodic clock carrier signal. In this way there is an integral number of clock cycles between reception of successive periodic carrier signals, simplifying the method of statistically determining local clock phase.

According to this aspect, the communication bus may be a serial bus, a parallel bus or any other form of communication bus, the devices being of the type attached to their respective bus. If a serial bus, the communication bus may be a Universal Serial Bus (USB), a PCI-Express bus, an Ethernet, a Firewire bus, or an RS232 or other serial interface bus. If a parallel bus, the communication bus may be a PCI bus, a PXI bus, a VME bus, a VXI bus, or a GPIB or other parallel interface bus. The communication bus may be between devices on a wired, optical or wireless bus, a backplane bus for a rack-based instrument, a bus on a printed circuit board or even an intra-chip bus.

The communication bus may be a single bus or a plurality of inter-connected busses. It is within the scope of this aspect that a plurality of devices attached to a plurality of different busses may all be synchronised. By way of example (but not limited to) USB devices, Ethernet devices and PCI devices may all be synchronised using this aspect of the invention.

Preferably the communication bus is a USB and the carrier signals comprise any of the USB packet signal structures defined in the USB specification, command sequences sent to said USB device, data sequences sent to the USB device, OUT tokens, IN tokens, ACK tokens, NAK tokens, STALL tokens, PRE tokens, SOF tokens, SETUP tokens, DATA0 tokens, DATA1 tokens, or predefined bit pattern sequences in the USB data packets.

According to a fifth broad aspect of the present invention, there is provided a method for improving the accuracy of synchronising the local clock of a plurality of devices attached to a communication bus comprising:
the method of the fourth aspect described above applied to a plurality of devices attached to a communication bus.

According to this aspect, the communication bus may be a serial bus, parallel bus or other form of communication bus and the devices being of the type attached to their respective bus.

In yet another broad aspect, the invention provides a method for synchronisation of a plurality of devices attached to a bus with respect to an externally provided reference signal.

According to this aspect, the local clocks of each of said plurality of devices are characterised over a period of time with respect to a periodic signal (carrier signal) of either the host controller or one of the devices on the bus by any of the methods taught in this disclosure. An external reference signal provided to at least one of said attached devices is also characterised with respect to said periodic signal structure. Information about said external reference signal is sent to each of said devices. The devices are then able to synthesise their local synchronous clocks in frequency and phase with said external signal.

Thus, according to a sixth aspect of the present invention, there is provided a method of synchronising a plurality of devices attached to a communication bus to an external signal provided to at least one of said devices, the method comprising:
using the measurement and prediction methods of the third aspect of the present invention to characterise the free-running oscillators of said plurality of devices;
using the measurement and prediction methods of the third aspect of the present invention to characterise an external signal provided to at least one of said plurality of devices; and
using the control method of the third aspect of the present invention to generate a synchronised local clock for each of said plurality of devices
wherein said local clocks are each synchronised to the timebase of said external signal.

In this way, a reference clock signal can be provided to one of a plurality of devices attached to the described bus and each of said attached devices can synthesise their local clocks to said external reference signal. The external reference signal can be a clock signal derived from (but not limited to) atomic reference clocks, the Global Positioning System (GPS), synchronised Ethernet protocols such as IEEE-1588, instrumentation chassis such as PXI, PXI-e, cPCI, VXI, VME or any other clock source.

To further illustrate this point, an example is presented of a GPS clock being applied to a first USB device which is attached to a USB host controller via a USB bus. This is by no means a limiting example, but merely an illustrative embodiment.

Thus, the USB host controller transmits a plurality of clock carrier signals to said first USB device. The carrier signals may be the periodic Start of Frame (SOF) signals. The carrier signals may alternatively be non-periodic signals that have been time stamped in the time domain of the USB host controller. The GPS clock is therefore characterised with respect to the carrier signals. An alternative way to view this scenario is that the carrier signals and hence the time domain of the USB host controller is characterised according to the GPS clock. In a similar way, a local oscillator of a second USB device attached to the USB can be characterised with respect to the carrier signals.

Both the first and second USB devices may be characterised using the same carrier signals, as would be the case with a broadcast carrier signal. Alternatively, the first and second USB devices may be characterised using different sets of carrier signals, as long as both sets of carrier signals originate from the same time domain, namely the USB host controller.

The time domain of the second USB device can therefore be mapped and synchronised to the GPS time domain as follows:
i) the GPS time domain is mapped to the USB host controller time domain via the carrier signals; and
ii) the time domain of the second USB device is mapped to the USB host controller time domain via the carrier signals.

It will be appreciated by the skilled person that the time domain of the second USB device may be mapped to a third device by a similar exchange of carrier signals in their respective time domains. It should also be noted that the third device need not be a USB device: it may be any device capable of communicating carrier and possibly time stamp information with the second device.

Thus, the third device may be a PCI bus, a PCI-Express bus, an Ethernet, a Firewire bus, a PCI-Express bus, an RS232 bus, a VME bus, a VXI bus, a GPIB or other serial or parallel interface bus. The communication busses may be located between devices on a wired, optical or wireless bus, a backplane bus for a rack-based instrument, a bus on a printed circuit board or an intra-chip bus.

This method of time domain mapping does not rely on an extremely accurate clock source for the carrier signal. Since it employs a mapping between time domains (which may even be non-periodic in nature provided they contain timestamps), devices may be synchronised to one another and, if desired, to an absolute time to a high degree regardless of the quality of the carrier signal information.

In a seventh broad aspect, the present invention provides a method of synchronising a plurality of devices attached to a plurality of inter-connected busses wherein the busses contain a variety of different types (including but not limited to USB, Ethernet and PCI), the method comprising:
the method of the first aspect applied between each of said plurality of devices (and bus controllers as appropriate) attached to said plurality of busses;
the prediction method of said third aspect applied to each of said plurality of devices (and bus controllers as appropriate) attached to said plurality of busses;
wherein said mapping comprises the interrelationship between timebases for each of said devices attached to each of said plurality of busses; and
a control stage (such as that of the third aspect) to generate a synchronised local clock for each of said plurality of devices attached to each of said plurality of busses.

Preferably the plurality of busses contain different bus types and/or the same bus types. For example this aspect applies equally well to a network comprising a USB, a PCI and two Ethernet busses or comprising a plurality of USB busses.

Preferably said control system comprises the control method of the third aspect of the present invention. It should be understood however that any means for generating a local clock signal synchronised to said mapping generated by said prediction system is equally applicable.

The busses may be simply connected, that is with only one connection path between any two nodes, or multiply-connected wherein a plurality of connection paths exists between any two nodes.

This broad aspect comprises a network of busses and devices where multiple cross measurements between timebases are made in order to build said interrelationships.

It should be noted that the various features of each of the above aspects of the invention can be combined as desired. It should also be noted that apparatuses and systems can be built based on the methods taught and vice versa.

In the various embodiments presented here, a local oscillator's notion of time is referred to a carrier signal on a communication bus. Said carrier signal does not necessarily correspond to an absolute notion of time, but it is understood by those skilled in the art that any appropriate time reference may be chosen from a system comprising several independent notions of time. Conversely said carrier signal may be tied to some traceable frequency standard. In fact, a given local oscillator may be chosen as the absolute time reference for a system (with said carrier signal calibrated against said reference) and choice of time frame ultimately comes down to the specific system.

Furthermore, any of the aspects of the present invention may be combined with measurement and compensation of signal propagation delays in the interconnections. This can be achieved using the methods of Foster et. al. (U.S. patent application Ser. No. 10/620,769) or any other compensation scheme including for example the methods of IEEE-1588.

In addition, apparatuses and systems according to the invention can be embodied in various ways. For example, such devices could be constructed in the form of multiple components on a printed circuit or printed wiring board, on a ceramic substrate or at the semiconductor level, that is, as a single silicon (or other semiconductor material) chip. Furthermore systems according to the present invention may be embodied as a plurality of components that function as a coordinated system or as a single functional unit, as would be readily appreciated by those skilled in the art.

According to a eighth broad aspect, the present invention provides a method of synchronising a first device and at least one second device, the first device having a local oscillator and the second device being in data communication with the first device via a communication bus, the method comprising:
the first device transmitting a plurality of carrier signals to the second device indicative of the time domain of the first device;
the second device using the plurality of carrier signals to measure the frequency of its local oscillator;
the first device transmitting a signal to the second device indicative of a required frequency to be synchronised to; and
the second device generating a local clock signal that is syntonised to the time domain of the first device.

In one embodiment, the first and second devices are USB devices and the communication bus is a USB.

In one embodiment, one of the first and second devices is a USB device and another of the first and second devices is a USB Host Controller.

The plurality of carrier signals may be periodic.

The plurality of carrier signals may be non-periodic, and transmitted at known times.

The method may include transmitting the respective known times to the second device.

The method may include transmitting the respective known times to the second device in the same data packet as the carrier signals.

The method may include transmitting the plurality of carrier signals near USB Start of Frame boundaries.

The method may include transmitting the plurality of carrier signals near one second boundaries of Coordinated Universal Time (UTC).

The method may include transmitting the plurality of carrier signals near one second boundaries of the Global Positioning System (GPS) time.

The method may include generating the local clock signal by a phase locked loop (PLL) architecture.

The local oscillator may be free running.

The method may include generating the local clock signal with a programmable counter/timer comprising a programmable prescaler and a programmable counter function, wherein the counter/timer is clocked from the local oscillator.

The method may include generating the local clock signal with a programmable counter/timer.

The programmable counter/timer may comprises a programmable prescaler, a programmable counter function and a mechanism for shifting the phase of the input local oscillator, the counter/timer being clocked from the local oscillator.

The counter/timer may be, for example, part of a microcontroller, part of a field programmable gate array device, part of a programmable logic device or part of a compound semiconductor device.

The communication bus may be, for example, a Peripheral Component Interconnect (PCI) bus, a PCI-Express bus, an Ethernet bus, a Firewire bus, or a wireless bus.

The plurality of carrier signals may be periodic, and the method include generating the local clock signal by a voltage controlled crystal oscillator (VCXO) or phase locked loop (PLL) architecture.

According to ninth broad aspect, the invention provides an apparatus, comprising:
a USB device with a local oscillator, a microcontroller and a counter/timer (such as in the form of counter/timer circuitry), wherein the USB device is configured to respond to substantially all of a plurality of bus derived time-stamped clock carrier signals;
circuitry configured to observe USB traffic, decode from a USB data stream a signal transmitted by a USB host controller and comprising a clock carrier signal containing information about a distributed clock frequency and phase, and to output a decoded carrier signal;
a first counter/timer (such as in the form of counter/timer circuitry) configured to measure the interval between receptions of the clock carrier signals in the time domain of the local oscillator, the measurement providing information about the frequency of the local oscillator with respect to the known carrier signal frequency;
wherein the apparatus is adapted to respond to a message from the USB host controller containing information about a required synchronisation frequency by calculating a setting for a second counter/timer (such as in the form of counter/timer circuitry) based on the synchronisation frequency and the frequency of the local oscillator, the USB device configuring the counter/timer of the USB device to generate an output signal upon reaching an output condition that comprises a terminal count event (in the case of a counter function) or a timeout event (in the case of a timer function where the second counter/timer is clocked by the local oscillator); and
the second counter/timer is configured such, that upon reaching the output condition (terminal count or timeout), the second counter/timer is reset to a new setting based on updated information about the frequency of the local oscillator and enabled once more.

According to tenth broad aspect, the invention provides a method of synchronising the local clock of a USB device attached to a USB host controller comprising:
the host controller transmitting a plurality of signals to the USB device, wherein the plurality of signals constitute a clock carrier signal of known time in the time domain of the USB host controller;
observing USB traffic by the USB device and decoding from the traffic the plurality of signals containing information about a distributed clock frequency and phase and outputting a decoded carrier signal;
measuring the interval between receptions of the decoded carrier signals in the time domain of the local clock, to provide information about the time domain of the USB host controller;
determining the phase of the local clock with respect to the plurality of decoded carrier signals;
the USB host controller transmitting the respective known times of substantially all of the clock carrier signals to the USB device;
the USB host controller transmitting a message to the USB device indicative of the required synchronisation frequency and phase; and
controlling the frequency and phase of the local clock so that the local clock is syntonised and in phase with the notion of time of the USB host controller.

The plurality of signals may be periodic.

The periodic signals may be USB Start of Frame (SOF) signals.

The method may include transmitting the respective known times to the USB device in the same data packet as the plurality of signals.

The method may include transmitting the plurality of carrier signals near one second boundaries of Coordinated Universal Time (UTC) or near one second boundaries of the Global Positioning System (GPS) time.

The local clock may comprise a phase locked loop (PLL) architecture or voltage controller crystal oscillator (VCXO).

The method may include generating the local clock by, for example, a field programmable gate array device or a programmable logic device.

The counter/timer may comprise, for example, a programmable prescaler and a programmable counter function, the counter/timer being clocked from the local oscillator.

The programmable counter/timer may further comprise a mechanism for shifting the phase of the input local oscillator.

The counter/timer may be part of a microcontroller.

According to eleventh broad aspect, the invention provides a method of synchronising a local clock of a USB device with the time domain of a USB Host controller attached thereto, the USB device having a local oscillator and containing counter/timer functionality, the method comprising:
the host controller transmitting a plurality of signals to the USB device, wherein the plurality of signals constitutes a clock carrier signal of known frequency in the time domain of the USB host controller;
observing USB traffic with the USB device and decoding from the USB traffic the plurality of signals containing information about a distributed clock frequency and phase and generating a decoded carrier signal therefrom;
measuring the interval between receptions of the decoded carrier signals with a first counter/timer function in the time domain of the local oscillator, and determining from the interval the frequency of the local oscillator with respect to the known carrier signal interval;
determining the phase of the local oscillator with respect to the plurality of decoded carrier signals;
the USB host controller transmitting a message to the USB device, the message containing information about the required local clock frequency;
calculating a setting for a second counter/timer function using the required local clock frequency and phase, and the frequency and phase of the local oscillator;
configuring the second counter/timer function to generate a local clock transition signal at a predetermined time in the time domain of the USB device;
wherein the second counter/timer function is clocked by the local oscillator; and
the local clock transition signal toggles the local clock output.

The local oscillator may be free-running.

The method may include transmitting the known times of the respective plurality of signals to the USB device in the same data packet as the plurality signals.

In one embodiment, a time series of readings from the first timer/counter contains information about the phase of the local oscillator at the time of receipt of each of the decoded carrier signals.

Configuring the second timer/counter may comprise setting a starting value that represents a number of the local oscillator cycles before the next required local clock transition.

The method may include generating the local clock transition signal upon the second timer/counter reaching terminal count in the case of a counter function.

The method may include generating the local clock transition signal upon the second timer/counter reaching a timeout condition in the case of a timer function.

The method may include repetitively making the measurement of local oscillator frequency and phase.

The method may include statistically analyzing the repetitive measurements of local oscillator frequency and phase and increasing the accuracy of the measurements thereby.

The method may include continually updating the configuration of the second counter/timer to maintain synchronisation of the local clock signal.

The first counter/timer function may be contained within, for example, a microcontroller, a field programmable gate array device or a programmable logic device.

The method may include reading the first counter/timer then resetting the first counter/timer on receipt of the decoded carrier signals.

The plurality of signals may be periodic.

The plurality of signals may be USB Start of Frame (SOF) signals.

The plurality of signals may be non-periodic, and the method include generating the signals at known times in the time domain of the USB Host controller.

The method may include transmitting the plurality of signals near USB Start of Frame (SOF) signals.

The method may include transmitting the plurality of carrier signals near one second boundaries of Coordinated Universal Time (UTC) or near one second boundaries of the Global Positioning System (GPS) time.

According to twelfth broad aspect, the invention provides a method of determining the frequency and phase of a local oscillator of a device having a local oscillator and attached to a communication bus, the method comprising:
the device monitoring bus traffic of the communication bus and decoding from the bus traffic a plurality of time carrier signal generated by at least one of a plurality of other devices attached to the bus;
the device measuring the interval between receptions of the decoded carrier signals in the time domain of the local oscillator, to provide information about the frequency of the local oscillator with respect to the known carrier signal interval; and
determining the phase of the local oscillator with respect to the plurality of decoded carrier signals;

The plurality of carrier signals may be time-stamped in the time domain of the respective second device.

The plurality of carrier signals may be not periodic.

The plurality of intervals between reception of the time-stamped carrier signals may provide a plurality of measurements of the local oscillator frequency in the time domain of the respective other devices.

In one embodiment, a time series of the intervals is indicative the phase of the local oscillator at the time of receipt of each of the decoded carrier signals.

In another embodiment, a time series of the intervals is indicative of the evolution of time according to the local oscillator in the time domain of the respective other devices.

The method may further comprise statistically analyzing the plurality of the measurements in the time domain of the respective other devices to improve the accuracy of the determination of the local oscillator frequency.

Measuring the interval between receptions of the decoded carrier signals in the time domain of the local oscillator may comprise counting the number of transitions of the local oscillator within a window gated by receptions of the time-stamped carrier signals.

In one embodiment, one of the other devices is a bus master device. The other devices may be peer devices.

According to thirteenth broad aspect, the invention provides a method of predicting the time of a first free-running clock at some future time in the time domain of at least one of a plurality of second clocks, comprising:
reading a data set containing a plurality of measurements of the local time of the first clock in the time domain of at least one of the plurality of second clocks;
computing a relationship between the time domain of the first clock and each of the plurality of second time domains;
extrapolating a relationship forward in time between the time domain of the first clock and at least one of the plurality of the second time domains; and
determining a local time of the first clock based at some future time, based on the relationship between the plurality of time domains.

The method may include improving the determining of the local time of the first clock with statistical analysis of the plurality of relationships between the plurality of time domains.

The extrapolation may comprise, for example, a linear, polynomial, exponential extrapolation technique or combinations thereof, or a Kalman or G-H filtering technique.

According to fourteenth broad aspect, the invention provides a method of predicting the time of a plurality of free-running clocks at some future time in the time domain of at least one of a plurality of reference clocks, comprising:
reading a data set containing a plurality of measurements of the local time of the plurality of free-running clocks in the time domain of at least one of the plurality of reference clocks;
computing a relationship between the time domain of each of the free-running clocks and each of the plurality of reference time domains;
extrapolating a relationship forward in time between the time domain of each of the free-running clocks and at least one of the plurality of the reference time domains; and
determining a local time of each of the free-running clocks at some future time, based on the plurality of the relationships between the plurality of time domains.

The method may include improving the determining of the local time of the free-running clocks by statistical analysis of the plurality of relationships between the plurality of time domains.

The extrapolation may comprise, for example, a linear, polynomial, exponential extrapolation technique or combinations thereof, or a Kalman or G-H filtering technique.

According to fifteenth broad aspect, the invention provides a method of controlling an event timed from a local oscillator, comprising:
receiving data indicative of a first time at which the event is to be generated in the time domain of the local oscillator;
generating a clock signal from the local oscillator;
resetting and configuring a counter/timer function with data indicative of the interval between the present time and the first time;
generating the event upon reaching a terminal count in the case of a counter function or a timeout in the case of a timer function;
clocking the counter/timer by the local oscillator.

The clock signal may be at the same frequency as and in phase with the local oscillator.

The clock signal may be a multiple of the frequency of and in phase with the local oscillator, wherein the clock signal provides greater clocking resolution than the local oscillator.

In one embodiment, the local oscillator is free-running.

In another embodiment, the local oscillator is a voltage controlled crystal oscillator (VCXO) or phase locked loop (PLL) and is locked to a required frequency.

According to sixteenth broad aspect, the invention provides a method of generating a local clock signal from a local oscillator, comprising:
i) receiving data indicative of a first time at which a transition of the local clock is to be generated in the time domain of the local oscillator;
ii) generating a clock signal from the local oscillator;
iii) resetting and configuring a counter/timer function with data indicative of the interval between the present time and the first time;
iv) generating the transition of the local clock upon reaching a terminal count event in the case of a counter function or a timeout event in the case of a timer function;
v) clocking the counter/timer by the local clock; and
vi) repeating steps i) to v) upon generation of the transition of the local clock one or more times.

The clock signal may be at the same frequency as and in phase with the local oscillator.

The clock signal may be a multiple of the frequency of and in phase with the local oscillator, wherein the clock signal provides greater clocking resolution than the local oscillator.

The local oscillator may be free-running.

In another embodiment, the local oscillator is a voltage controlled crystal oscillator (VCXO) or phase locked loop (PLL) and is locked to a required frequency.

The method may include adjusting or dithering the configuration of the counter timer between several settings in order to provide finer control of the frequency and phase of the local clock signal.

According to seventeenth broad aspect, the invention provides a method of synchronising data acquired by a plurality of unsynchronised devices attached to a common communication bus, comprising:
determining a mapping between unsynchronised time domains of the plurality of devices, comprising:
   determining the frequency and phase of a local oscillator of each of the devices according to the method described above; and
   predicting the time of the local oscillator at some future time in the time domain of at least one of a plurality of second local oscillators according to the method described above;
time stamping the data acquired in the time domain of each respective device;
transmitting the time stamped data to a central location; and
time aligning the data from the plurality of devices in a common time domain.

According to eighteenth broad aspect, the invention provides a method of synchronising data acquired by a plurality of unsynchronised USB devices attached to a USB, each having a free-running local oscillator, the method comprising:
the plurality of USB devices monitoring the USB traffic and decoding from the USB a plurality of time carrier signals generated by a USB host controller;
the plurality of USB devices measuring the interval between receptions of the decoded carrier signals in the time domain of the local oscillator, to provide information about the frequency of the local oscillator with respect to the known carrier signal interval; and
determining the phase of the local oscillator of each of the respective USB devices with respect to the plurality of decoded carrier signals;
the plurality of USB devices acquiring data wherein data acquisition is clocked by the respective free-running local oscillators;
time stamping the data acquired in the time domain of each respective USB device;
transmitting the time stamped data to a central location; and
time aligning the data from the plurality of devices in a common time domain.

According to nineteenth broad aspect, the invention provides a system for synchronising the local oscillator of one or more devices to a bus derived timebase, comprising:
a measurement stage adapted to characterise the local oscillators with respect to the bus derived timebase;
a prediction stage adapted to determine the evolution of time in each of the local oscillators; and
a control stage adapted to generate a synchronous clock signal local to each of the respective devices from the respective local oscillators.

In one embodiment:
the measurement stage is adapted to perform the method of determining the frequency and phase of a local oscillator of a device described above;
the prediction stage is adapted to perform the method of predicting the time of a first free-running clock at some future time described above; and
the control stage is adapted to perform the method of controlling an event timed from a local oscillator described above.

The prediction stage may comprise a centrally located computing mechanism and the system adapted to transmit data indicative of the first time to each of the devices.

In one embodiment, a plurality of the computing mechanisms are located within each of the respective devices, with data indicative of the first time being calculated locally to each of the devices.

According to nineteenth broad aspect, the invention provides a method of synchronising a plurality of devices, each having a local oscillator, connected via a communication bus comprising:
designating a first or master timing device chosen from the plurality of devices;
the master timing device transmitting a plurality of clock carrier signals to each of a plurality of second devices;
each of the plurality of second devices determining the frequency and phase of their respective local oscillators with respect to the time domain of the master timing device according to the method of determining the frequency and phase of a local oscillator of a device described above;
predicting the evolution of time in each of the plurality of other devices in the time domain of the master timing device according to the method of predicting the time of a first free-running clock at some future time described above; and
synchronising a local clock of each of the plurality of devices with the notion of time of the master timing device according to the method of controlling an event timed from a local oscillator described above.

The method may include centrally calculating data indicative of the first time and transmitted the data to each of the devices.

In another embodiment, the method includes calculating data indicative of the first time locally to each of the devices.

The clock carrier signals may be periodic.

In another embodiment, the clock carrier signals are non periodic, and are time-stamped or transmitted at known times in the time domain of the master timing device.

According to twentieth broad aspect, the invention provides a method of synchronising a plurality of devices, each having a local oscillator, connected via a plurality of interconnected communication busses comprising:
designating a master timing device for each bus interconnection, chosen from the plurality of devices;
the plurality of master timing devices transmitting a plurality of clock carrier signals to each of the plurality of other devices;
each of the plurality of other devices determining the frequency and phase of their respective local oscillators with respect to the time domain of the master timing device according to the method of determining the frequency and phase of a local oscillator of a device described above; and
predicting the evolution of time in each of the plurality of other devices in the time domain of the master timing device according to the method of predicting the time of a first free-running clock at some future time described above; and
synchronising the local clock of each of the plurality of devices with the notion of time of the master timing device according to the method of controlling an event timed from a local oscillator described above.

The evolution of time in each of the plurality of devices across a plurality of interconnected communication busses may be known to arbitrary precision, and the accuracy of clock carrier signal frequency known to a lesser degree.

It should also be noted that any of the various features of each of the above aspects of the invention can be combined as suitable and desired.

### BRIEF DESCRIPTION OF THE DRAWING

In order that the present invention may be more clearly ascertained, embodiments will now be described, by way of example, with reference to the accompanying drawing, in which:

FIG. 1 is a schematic diagram of a synchronised USB device according to a first broad aspect of the present invention;

FIG. 2 is a schematic representation of a microcontroller as used in a first broad aspect of the present invention;

FIG. 3 is a schematic representation of the internal resources and architecture of the microcontroller of FIG. 2;

FIG. 4 is a schematic representation of a synchronised USB according to a second embodiment of the present invention;

FIG. 5 is a schematic representation of a USB synchronised to a GPS time server according to a third embodiment of the present invention;

FIG. 6 is a schematic representation of a network of synchronised devices synchronised across a PCI bus according to a fourth embodiment of the present invention;

FIG. 7 is a schematic representation of a hybrid network of synchronised interconnected busses according to a fifth embodiment of the present invention; and

FIG. 8 is a schematic representation of carrier and synchronisation signals for a syntonised system.

### DETAILED DESCRIPTION OF THE EMBODIMENTS

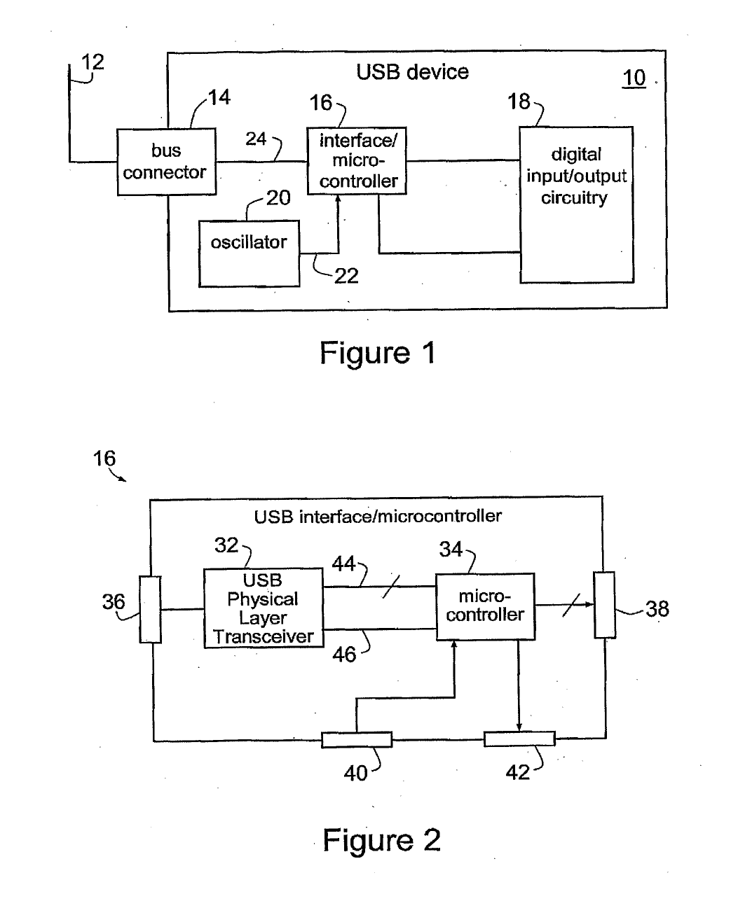

A USB device according to a first embodiment of the present invention is shown schematically at 10 in FIG. 1, with a digital USB 12. USB device 10 includes a bus connector 14, for connection to USB 12, a USB interface/microcontroller 16, digital input/output circuitry 18 (in the form, for example, of a digital transducer such as an analogue to digital converter, pressure transducer or strain gauge) and a free-running oscillator 20. Oscillator 20 provides a clock signal 22 for USB interface/microcontroller 16. USB interface/microcontroller 16 has a data bus 26 which controls digital input/output circuitry 18.

USB interface/microcontroller 16 is configured to compare clock signal 22 with a clock carrier signal decoded internally from USB traffic 24.

The frequency of an oscillator is measured in cycles per second. Oscillators are often used as clocks and each cycle of an oscillator can be considered a single “tick” of the clock. Time may therefore be measured in terms of the number of ticks of an oscillator. This provides a local notion of time, so the oscillator may also be referenced to some absolute (or more authoritative) notion of time, if available. In this way, the carrier signal decoded from USB traffic 24 provides another timebase for comparison. If this carrier signal contains a more accurate notion of absolute time (or even a chosen appropriate timebase for the given system) then local oscillator 20 may be calibrated against that carrier signal.

In the case of a USB, clock signal 22 of local free-running oscillator 20 is referred to the Start of Frame (SOF) packet carrier signal. This results in a system which is referenced to the local clock of the USB host controller. SOF packets are numbered with a 12-bit number that rolls over at 2048. However it is possible for the operating system of the host controller to maintain a larger bit-count number as its time reference. This is desirable for maintaining a significant USB host controller timebase that can then be compared to other interconnected busses if required.

Thus, as discussed above, clock synchronization information in the form of a repetitive clock carrier signal is decoded from USB traffic 24 from USB 12 by USB interface/microcontroller 16. FIG. 2 is a schematic representation of USB interface/microcontroller 16 of FIG. 1, showing its internal circuitry. USB interface/microcontroller 16 includes a USB Physical Layer Transceiver (Phy) 32 and conventional microcontroller 34. USB Phy 32 receives USB traffic through USB interface port 36. Microcontroller 34 has a plurality of output ports (represented collectively at 38), a clock source input port 40 and a dedicated synchronised clock generation output 42; synchronised clock generation output 42 may in fact be a dedicated one of the plurality of output ports 38.

USB Phy 32 is connected to microcontroller 34 via a data bus 44 and via an additional hardware interrupt signal connection 46. Hardware interrupt signal connection 46 allows USB Phy 32 to inform microcontroller 34 of the receipt of a nominated carrier signal from the USB traffic.

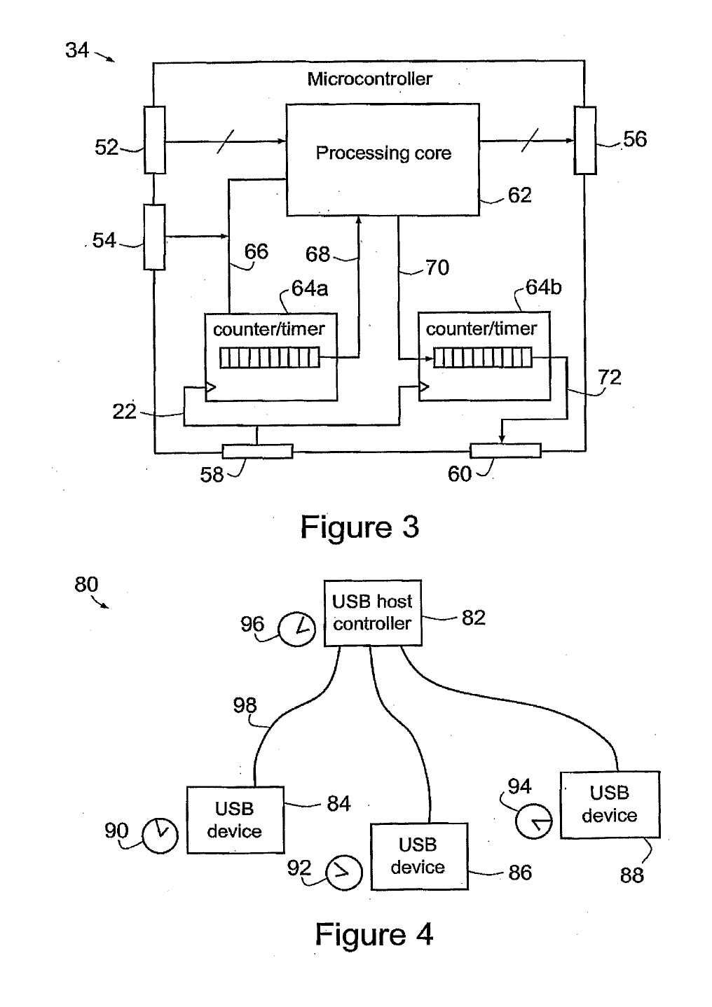

FIG. 3 is a schematic representation of microcontroller 34 of USB interface/microcontroller 16. Microcontroller 34 has an input 52 for data bus 44 of FIG. 2, SOF interrupt input port 54, a plurality of output ports (represented collectively at 56, and connected to or integral with output ports 38 of USB interface/microcontroller 16), a clock source input port 58 and a dedicated synchronised clock generation output 60 (connected to or integral with clock source input port 40 and a dedicated synchronised clock generation output 42 of USB interface/microcontroller 16). Microcontroller 34 also contains a processing core 62 (which typically contains memory and other functionality) and first and second counter/timers 64a and 64b.

First counter/timer 64a is adapted to measure the local oscillator time (or frequency) with respect to the SOF carrier signal 66. Second counter/timer 64b is clocked by local clock signal 22 from clock source input port 58. SOF carrier signal 66 is used to gate first counter/timer 64a so that second counter/timer 64b counts ticks (or times the period) of local clock signal 22 in the period between receptions of successive SOF carrier signals 66. A measurement result 68 of first counter/timer 64a, comprising a digital representation of time (counts) in the period defined by successive SOF receptions, is transmitted by first counter/timer 64a to processing core 62, and processing core 62 determines time in the time domain of USB device 10 from this measurement result 68.

Conventional USB microcontrollers (such as the Cypress EZUSB-FX series of USB microcontrollers) can be configured to execute a software interrupt on reception of the Start of Frame (SOF) packet in the USB data stream. In this embodiment an interrupt service routine provided in microcontroller 34 is executed in response to receipt of the SOF packet, and is configured to generate a reference timing signal (at either 1 kHz for USB Full Speed or 8 kHz for USB High Speed), which is used to gate first counter/timer 64a.

A plurality of such measurement results 68 of local clock time (or frequency/period) are conducted, and processing core 62 applies statistical techniques to these results 68 to determine a final result of increased accuracy. This periodic determination of the local clock time is described in the third broad aspect of the present invention as the measurement method.

According to a prediction method of this embodiment, USB device 10 determines how second counter/timer 64b should be configured to maintain time synchronisation with the time domain of the USB 12. The values that are loaded to counter/timer 64b are based on the notions of time of each time domain—in this case, the SOF time domain (Host Controller) and that of local oscillator 20 (of USB device 10).

Second counter/timer 64b is operated according to the control method of the third broad aspect of the present invention described above. Thus, second counter/timer 64b is clocked from local clock signal 22, so is in the time domain of local oscillator 20. Microcontroller processing core 62 periodically pre-configures counter/timer 64b with a value 70. Second counter/timer 64b may either be operating in timer mode or counter mode with appropriate control signals sent from processing core 62. When second counter/timer 64b either reaches terminal count or a timeout condition, a hardware signal 72 is generated on synchronised clock generation port 60. This hardware signal 72 can be used to toggle a clock pin or other function of microcontroller 34.

It will be evident to those skilled in the art that judicious temporary changes in the values 70 loaded into second counter/timer 64b will lead to changes in phase of the output signals. Permanent changes in the loaded values 70 will result in a frequency change. For example, a 10 MHz local clock syntonised with its 125 μs carrier signal (i.e. with an integer number of cycles between reception of successive USB SOF carrier signals) has a period of 100 ns, so 1250 cycles occur in each 125 μs SOF period. If second counter/timer 64b is loaded with 1250 and there is no change in clock frequency there will be no change in the phase relationship at the next SOF packet reception.

On the other hand, if the phase of the local clock needs to be advanced by 100 ns, then a value of 1249 would be loaded to second counter/timer 64b for one SOF period and then 1250 would be loaded for each subsequent SOF period.

According to a second embodiment of the present invention there is provided a synchronised USB shown schematically at 80 in FIG. 4. Synchronised USB 80 comprises a USB host controller 82 and a plurality of USB devices 84, 86 and 88 (each with the features of USB device 10 of FIG. 1). USB devices 84, 86, 88 each has a free-running oscillator or clock 90, 92, 94, respectively. USB host controller 82 has, and is driven by, a local clock 96, and generates periodic SOF packets which it broadcasts to USB devices 84, 86, 88.

USB devices 84, 86, 88 each generates a synchronised local clock according to the method described above in the first embodiment. USB device 84 measures the rate of its internal oscillator 90 versus the timebase of clock 96 of USB host controller 82 (timed by periodic SOF packet reception) across USB connection 98. Similarly USB devices 86 and 88 measure their local clock rates using the same broadcast SOF packets from USB host controller 82.

The measurement method of the third broad aspect of the present invention therefore provides an array of data comprising the local time (of respective oscillators 90, 92, 94) at each USB device 84, 86, 88 corresponding to the receipt of this periodic SOF carrier signal (i.e. the timebase of the USB host controller 82).

Furthermore, according to the prediction method of the third aspect a mapping of the relative time of each of oscillators 90, 92, 94 and clock 96 is generated, extrapolated forward. According to the control method of the third aspect, each of USB devices 84, 86, 88 is configured such that a counter/timer function on each of USB devices 84, 86, 88 synchronously outputs a clock signal when clocked from its respective free-running oscillator 90, 92, 94.

The higher the clock rate of the local oscillator 90, 92, 94, the more precision is achievable with controlling frequency. It should however be noted that, as a local oscillator frequency is multiplied up, the frequency stability of the local oscillator must be tighter for a given control loop period.

The frequency stability of local oscillators 90, 92, 94 determines how often the measurement, prediction and control loop should be performed. If local oscillators 90, 92, 94 are provided in the form of standard crystal oscillator chips operating at 48 MHz with a frequency tolerance of 100 parts per million (ppm), and if it is assumed that the periodic carrier signal corresponds to USB SOF packet tokens occurring at exactly the ideal 125 μs intervals, then in each 125 μs interval there will be 6000 ticks of the 48 MHz clock. If the clock is at the end of its tolerance band then the frequency would be 48.00048 MHz. This results in 6000.06 ticks in the 125 μs interval. The local oscillator would be in error by one cycle of the 48 MHz clock (approximately 20 ns) every 17 microframe periods (roughly every 2 ms).

Assuming that the control resolution is one clock tick at 48 MHz, the control loop only needs to operate at about once every 2 ms or 500 Hz. Similarly if a high specification local clock source is used, such as an Oven Controlled Crystal Oscillator (OCXO) the stability of the clock allows a very infrequent control loop.

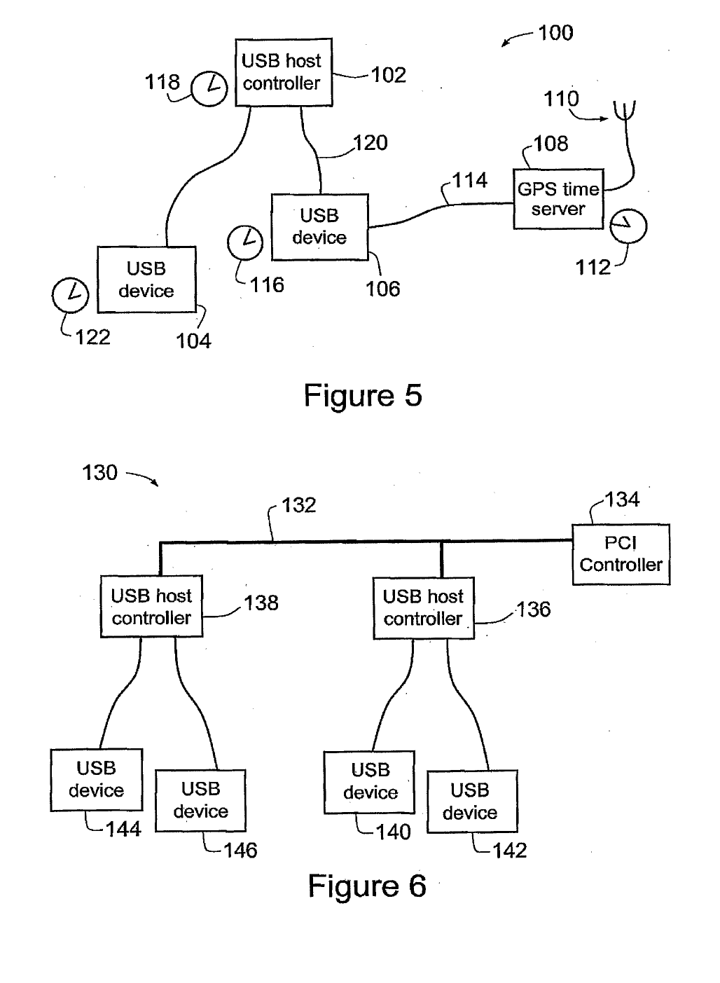

FIG. 5 is a schematic diagram of a USB 100 synchronised to a GPS clock according to a third embodiment of the present invention. According to this embodiment, synchronised USB 100 comprises a USB host controller 102 and a plurality of USB devices 104 and 106 in data communication therewith. USB device 106 is additionally connected to a GPS time server 108. GPS time server 108 receives time codes from the GPS (or equivalent) satellite system via aerial 110 and maintains a local clock 112 accurate to universal time with high precision.

GPS time server 108 transmits one pulse per second on the Universal Time second boundary (1 PPS signal) via data connection 114 to USB device 106. Other time or clock signals may be used, such as the 10 MHz clock signal. These 1 PPS signals can be considered a periodic clock carrier signal transmitted across data connection 114. USB device 106 is functionally equivalent to USB device 10 of FIG. 1 and is therefore adapted to implement the methods of the third aspect of the present invention to measure and map the relative times of local clock 112 of GPS time server 108 and clock 116 of USB device 106. In this regard, USB device 106 is adapted such that these 1 PPS signals generate interrupt rather than receptions of SOF packets as in the embodiments described above.

Furthermore, USB host controller 102 is transmitting periodic SOF packets to USB device 106, so USB device 106 can use the methods of the third aspect of the present invention to measure and map the time of its local clock 116 relative to the time of the local clock 118 of USB host controller 102. Depending on the resources available to the microcontroller used it may be possible to adapt one counter/timer resource to measure the time of each data connection 114 and data connection 120 between USB host controller 102 and USB device 106. If insufficient resources are available to measure both simultaneously, then the available resources can be shared between measuring the relative time of each data connection 114 and 120.

USB device 104 is able to characterise its local clock 122 by direct measurement against the timebase provided by local clock 118 of USB host controller 102, as described above for USB device 10 of FIG. 1.

After measurement of the relative times of each clock in the system (i.e. local clock 112 of GPS time server 108, local clock 116 of USB device 106, local clock 118 of USB host controller 102 and local clock 112 of USB device 104), USB 100 generates a predicted map of the relative time of these four clocks, a procedure equivalent to the prediction method of the third aspect of the invention described above.

The control method of the third aspect of the invention is then applied to generate a synchronised clock for each of USB devices 104, 106. The synchronised clocks are synchronous with local clock 112 of GPS time server 108, but need not be.

It should be noted that, in this scenario, the absolute accuracy of clocks 116 and 118 do not affect the ability to synchronise clock 122 of USB device 104 with clock 112 of GPS time server 108 to a high degree of accuracy. The relative mapping between all time domains is such that, provided drift in each clock is not significant, clocks can be widely separated and connected through inaccurate clocks but still be synchronised to a high degree of accuracy. The methodology is also thus relatively insensitive to stochastic jitter owing to the statistical processing of measurements.

In a fourth embodiment of the present invention, there is provided a plurality of USBs synchronised across a PCI bus, as depicted schematically at 130 in FIG. 6. According to this embodiment, a PCI bus 132 controlled by PCI Controller 134 hosts a plurality of USB host controllers 136, 138. Each of USB host controllers 136, 138 hosts a plurality of USB devices 140, 142 and 144, 146 respectively.

USB Host Controller 136 compares its local oscillator with a clock signal present on PCI bus 132 (generated by PCI Controller 134). Using techniques in line with those taught above, the clock signal from PCI bus 132 is compared to a local clock signal present inside the plurality of USB host controllers 136, 138. Similarly USB host controller 138 compares its local oscillator to a clock signal present on PCI bus 132. The measurement, prediction and control of these three clocks allows the plurality of USB host controllers 136, 138 to be synchronised according to the method of the third aspect of the present invention described above.

The plurality of USB devices 140, 142 hosted by USB host controller 136 are synchronised to USB host controller 136, and USB devices 144, 146 hosted by USB host controller 138 are synchronised to USB host controller 138. Thus, USB devices 140, 142, 144 and 146 are synchronised across PCI bus 132.

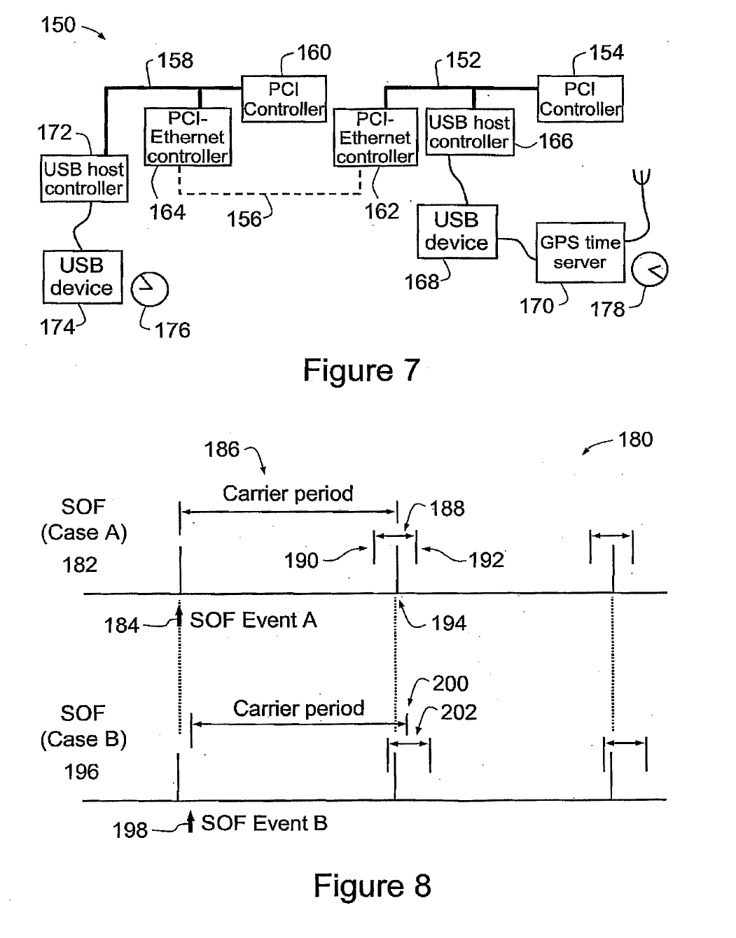

A hybrid network of interconnected busses according to a fifth embodiment of the present invention is shown schematically at 150 in FIG. 7, connected to a GPS time server. According to this embodiment, network 150 comprises a PCI bus 152 controlled by a PCI Controller 154 and, connected thereto by an Ethernet bus 156, a PCI bus 158 controlled by a PCI Controller 160. Network 150 also includes a PCI-Ethernet controller 162 connected to PCI bus 152 and a PCI-Ethernet controller 164 connected to PCI bus 158 to host Ethernet link 156.

PCI bus 152 contains a USB host controller 166 supporting a USB device 168 which is in turn connected to the GPS time server 170. PCI bus 158 contains a USB host controller 172 supporting USB device 174. In view of the various methods of the present invention described above, it will be apparent to the skilled person that each interconnected node (PCI controllers 154, 160, USB host controllers 166, 172, Ethernet controllers 162, 164, USB device 16 and GPS time server 170) is able to compare its local clock signal (time) to that of its neighbouring node. In this way a map of the relative timebases of the interconnections is developed thereby allowing each node to be synchronised.

As a result, the local clock 176 of USB device 174 can be synchronised to GPS time 178 through the chain of interconnected hybrid communication busses. In this embodiment, the absolute accuracy of the intermediate clocks does not affect the ability to synchronise clock 176 of USB device 174 with GPS time 178 to a high degree of accuracy. The relative mapping between all time domains is such that, provided drift in each clock is not significant, clocks can be widely separated across multiple hybrid bus connections with inaccurate clocks but still be synchronised to a high degree of accuracy. The methodology is also quite insensitive to stochastic jitter due to the statistical processing of measurements.

In the fourth and fifth embodiments described above (cf. FIGS. 6 and 7 respectively), a plurality of PCI busses are synchronised with various other busses. It will be evident to those skilled in the art that a PXI bus may also be synchronised. PXI is an industrial instrumentation standard that combines a standard PCI bus with a dedicated timing and triggering bus. The previous embodiments can therefore equally employ PXI busses, wherein the inaccurate PCI clock source is replaced with a precision and phase aligned clock source on the PXI timing bus.

The description above of synchronisation according to the present invention predominantly refers to synchronisation of clocks in frequency and phase to the reception of a carrier signal, without reference to compensation for propagation delays of the carrier signals across the busses. In some cases, as with PCI, differences in propagation time of the bus clock carrier signal from device to device are very small owing to the physically limited nature of the bus. In other cases, such as Ethernet, the physical extent of the bus results in significant propagation delays from point to point. USB is between these extremes, with device to device propagation discrepancies limited to only a few hundred nanoseconds.

Regardless, methods exist for measuring the propagation times for signals across these busses and for compensating for USB propagation delay (see, for example, Foster et al., U.S. patent application Ser. No. 10/620,769, in corporated herein by reference). PCI busses requires special termination conditions. As such it is possible to locate a given device's signal propagation time from a PCI bus controller by means of multi-level signalling. Similarly techniques exist with Ethernet to measure and compensate for signal propagation delays from simple techniques to methods taught by the IEEE-1588 standard.

In a sixth preferred embodiment of the present invention, a method is presented for improving the accuracy of synchronisation for a system of syntonised clocks attached to a communication bus. FIG. 8 is a schematic representation 180 of the time sequence of signals in two cases to illustrate this method for the case of a USB.

In this case a syntonised USB is presented, in which the local clock is locked to a statistically averaged carrier signal (SOF packet) frequency. In this way the time between successive receptions of SOF packets is an integer multiple of the local clock period and centred on the statistically averaged carrier reception time.

Conventional synchronisation methods employ a singular event to synchronise the syntonised clocks. This is acceptable in hardware triggered systems but software-based system suffer from significant random uncertainty in the time between detection of any singular SOF packet and generating a resulting control signal.

Referring to FIG. 8, Case A 182 represents a carrier signal (SOF) in time. A singular SOF synchronisation event is detected and output by software Interrupt service routine at 184. This represents the ideal case where the singular event is at the average of the delay between detection of any singular SOF packet and generating a resulting control signal. One carrier period later (at 186) the next SOF signal is detected, but the uncertainty in generating a local control signal 188 results in the control signal being either “early” at 190 or “late” at 192 with respect to the carrier period 186. In this case, the distribution of carrier signal reception within uncertainty window 188 will be centred on the expected carrier signal location 194 because the singular event was synchronised with the carrier signal.

Case B 196 also represents a carrier signal (SOF) in time. A singular SOF synchronisation event is detected and output by software Interrupt service routine at 198. In this case, the SOF event output is near the later extreme of its expected delay from ideal. The system has no knowledge of this random error for a singular event. One carrier period later (at 200) the next SOF is detected, but the random output delay (due to interrupt service routine uncertainty) results in a window of possible output 202. Over time, a pattern will emerge showing that detection of carrier signals have a distribution centred at 200, after the expected reception time based on local clock which is locked to the average reception of carrier signals.

In this way, a singular synchronisation event can be statistically compared to the average carrier signal time. The device's local notion of time can therefore be adjusted to compensate for the error in singular event and increasing the synchronisation accuracy.

Modifications within the scope of the invention may be readily effected by those skilled in the art. It is to be understood, therefore, that this invention is not limited to the particular embodiments described by way of example hereinabove and that combinations of the various embodiments described herein are readily apparent to those skilled in the art and within the scope of this disclosure.

In the preceding description of the invention, except where the context requires otherwise owing to express language or necessary implication, the term “Host Controller” refers to a standard USB Host controller, a USB-on-the-go Host Controller, a wireless USB Host Controller or any other form of USB Host Controller.

In the preceding description of the invention and in the claims that follow, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge.

1-103. (canceled)

104. A method of synchronising a first device and at least one second device, each having a local oscillator and a microcontroller, and the second device being in data communication with the first device via a communication bus, the method comprising:
said first device transmitting a plurality of signals to said second device;
said second device using said plurality of signals to measure the frequency of its local oscillator;
said first device transmitting a signal to said second device indicative of a required frequency to be synchronised to; and
said second device employing its microcontroller to configure itself to generate a local clock signal with said required frequency using the frequency of its local oscillator.

105. An apparatus, comprising:
a USB device with a local clock, a microcontroller with counter/timer functionality and an oscillator, wherein the microcontroller is configured to respond to a predefined software interrupt by generating an output signal adapted to be used as a synchronization reference signal for substantially all of a plurality of clock carrier signals, said USB device being attachable to a USB host controller;
circuitry configured to observe USB traffic, decode from a USB data stream a periodic signal transmitted by said host controller and comprising a clock carrier signal containing information about a distributed clock frequency and phase, and to output a decoded carrier signal;
circuitry configured to receive said decoded carrier signal, to generate said predefined software interrupt upon receipt of a predefined data packet and to pass the software interrupt to the microcontroller;
circuitry to measure the interval between receptions of said synchonisation reference signals in the time domain of said local oscillator, said measurement providing information about the frequency of said local oscillator with respect to the known carrier signal frequency;
wherein said apparatus is adapted to respond to a message from said USB host controller containing information about a required synchronisation frequency by calculating a setting for a second counter/timer circuitry based on said synchronisation frequency and said frequency of said local oscillator, said USB device setting the configuration of said counter/timer circuitry within said microcontroller to generate an output signal upon reaching a terminal count event in the case of a counter function or a timeout event in the case of a timer function;
wherein said second counter/timer is clocked by said oscillator; and
upon said second counter/timer reaching said terminal count or said timeout event resetting said configuration of said counter/timer.

106. A method of synchronising the local clock of a USB device having a microcontroller and a local oscillator attached to a USB host controller, said microcontroller containing counter/timer functionality, the method comprising:
said host controller transmitting a periodic signal to said USB device, wherein said periodic signal constitutes a clock carrier signal;
observing USB traffic and decoding from a USB data stream said periodic signal containing information about a distributed clock frequency and phase and outputting a decoded carrier signal;
receiving said decoded carrier signal, generating an interrupt upon receipt of a predefined data packet and passing the software interrupt to the USB microcontroller;
said USB microcontroller responding to the software interrupt by generating an output signal adapted to be used as a synchronization reference signal for substantially all of said clock carrier signals;
measuring the interval between receptions of said synchonisation reference signals in the time domain of said local oscillator, to provide information about the frequency of said local oscillator with respect to the known carrier signal frequency;
said USB host controller transmitting a message to said USB device, said message containing information about the required synchronisation frequency;
calculating a setting for a second counter/timer circuitry using said synchronisation frequency and said frequency of said local oscillator;
said USB device setting the configuration of said counter/timer circuitry within said microcontroller to generate an output signal upon reaching a terminal count event in the case of a counter function or a timeout event in the case of a timer function;
wherein said second counter/timer is clocked by said local oscillator; and
upon said second counter/timer reaching said terminal count or said timeout event resetting said configuration of said counter/timer.

107. A method for improving the accuracy of local clock phase synchronisation, the method comprising:
syntonising a local clock of a device attached to a communication bus;
decoding bus traffic of said communication bus for a predefined periodic carrier signal;
determining a phase of a local clock signal of said local clock at the instant of reception of each of said periodic carrier signals;
determining with statistical methods a true phase of said local clock signal with respect to said periodic carrier signals; and
adjusting the phase of said local clock such that said local clock is synchronised.

108. A method for improving the accuracy of synchronising the respective local clocks of a plurality of devices attached to a communication bus comprising:
syntonising said local clocks;
each of said devices decoding bus traffic of said communication bus for a predefined periodic carrier signal;
each of said devices determining a phase of a local clock signal of its local clock at the instant of reception of each of said periodic carrier signals;
each of said devices determining with statistical methods a true phase of its local clock signal with respect to said periodic carrier signals; and
each of said devices adjusting the phase of its local clock such that said local clock is synchronised.

109. A method of synchronising a first device and at least one second device, said first device having a local oscillator and said second device being in data communication with said first device via a communication bus, the method comprising:
said first device transmitting a plurality of carrier signals to said second device indicative of the time domain of said first device;
said second device using said plurality of carrier signals to measure the frequency of its local oscillator;
said first device transmitting a signal to said second device indicative of a required frequency to be synchronised to; and
said second device generating a local clock signal that is syntonised to the time domain of said first device.

110. A method as claimed in claim 109, wherein one of said first and second devices is a USB device and another of said first and second devices is a USB Host Controller.

111. A method as claimed in claim 109, wherein said plurality of carrier signals are periodic.

112. A method as claimed in claim 109, wherein said plurality of carrier signals are non-periodic, and transmitted at known times.

113. A method as claimed in claim 109, including transmitting said plurality of carrier signals near USB Start of Frame boundaries.

114. An apparatus, comprising:
a USB device with a local oscillator, a microcontroller and a counter/timer, wherein said USB device is configured to respond to substantially all of a plurality of bus derived time-stamped clock carrier signals;
circuitry configured to observe USB traffic, decode from a USB data stream a signal transmitted by a USB host controller and comprising a clock carrier signal containing information about a distributed clock frequency and phase, and to output a decoded carrier signal;
a first counter/timer configured to measure the interval between receptions of said clock carrier signals in the time domain of said local oscillator, said measurement providing information about the frequency of said local oscillator with respect to the known carrier signal frequency;
wherein said apparatus is adapted to respond to a message from said USB host controller containing information about a required synchronisation frequency by calculating a setting for a second counter/timer based on said synchronisation frequency and said frequency of said local oscillator, said USB device configuring said counter/timer of said USB device to generate an output signal upon reaching an output condition that comprises a terminal count event or a timeout event; and
said second counter/timer is configured such, that upon reaching said output condition, said second counter/timer is reset to a new setting based on updated information about the frequency of said local oscillator and enabled once more.

115. A method of synchronising the local clock of a USB device attached to a USB host controller comprising:
said host controller transmitting a plurality of signals to said USB device, wherein said plurality of signals constitute a clock carrier signal of known time in the time domain of said USB host controller;
observing USB traffic by said USB device and decoding from said traffic said plurality of signals containing information about a distributed clock frequency and phase and outputting a decoded carrier signal;
measuring the interval between receptions of said decoded carrier signals in the time domain of said local clock, to provide information about the time domain of said USB host controller;
determining the phase of said local clock with respect to said plurality of decoded carrier signals;
said USB host controller transmitting the respective known times of substantially all of said clock carrier signals to said USB device;
said USB host controller transmitting a message to said USB device indicative of the required synchronisation frequency and phase; and
controlling the frequency and phase of said local clock so that said local clock is syntonised and in phase with the notion of time of said USB host controller.

116. A method of synchronising a local clock of a USB device with the time domain of a USB Host controller attached thereto, said USB device having a local oscillator and containing counter/timer functionality, the method comprising:
said host controller transmitting a plurality of signals to said USB device, wherein said plurality of signals constitutes a clock carrier signal of known frequency in the time domain of said USB host controller;
observing USB traffic with said USB device and decoding from said USB traffic said plurality of signals containing information about a distributed clock frequency and phase and generating a decoded carrier signal therefrom;
measuring the interval between receptions of said decoded carrier signals with a first counter/timer function in the time domain of said local oscillator, and determining from said interval the frequency of said local oscillator with respect to the known carrier signal interval;
determining the phase of said local oscillator with respect to said plurality of decoded carrier signals;
said USB host controller transmitting a message to said USB device, said message containing information about the required local clock frequency;
calculating a setting for a second counter/timer function using the required local clock frequency and phase, and said frequency and phase of said local oscillator;
configuring said second counter/timer function to generate a local clock transition signal at a predetermined time in the time domain of said USB device;
wherein said second counter/timer function is clocked by said local oscillator; and
said local clock transition signal toggles said local clock output.

117. A method as claimed in claim 116, wherein local oscillator is free-running.

118. A method as claimed in claim 117, including transmitting the known times of said respective plurality of signals to said USB device in the same data packet as said plurality signals.

119. A method as claimed in claim 118, wherein a time series of readings from said first timer/counter contains information about the phase of the local oscillator at the time of receipt of each of said decoded carrier signals.

120. A method as claimed in claim 119, wherein configuring said second timer/counter comprises setting a starting value that represents a number of said local oscillator cycles before the next required local clock transition.

121. A method as claimed in claim 120, including generating said local clock transition signal upon said second timer/counter reaching terminal count in the case of a counter function.

122. A method of determining the frequency and phase of a local oscillator of a device having a local oscillator and attached to a communication bus, the method comprising:
the device monitoring bus traffic of said communication bus and decoding from said bus traffic a plurality of time carrier signal generated by at least one of a plurality of other devices attached to said bus;
said device measuring the interval between receptions of said decoded carrier signals in the time domain of said local oscillator, to provide information about the frequency of said local oscillator with respect to the known carrier signal interval; and
determining the phase of said local oscillator with respect to said plurality of decoded carrier signals;

123. A method as claimed in claim 122, wherein said plurality of carrier signals are time-stamped in the time domain of said respective second device.

124. A method as claimed in claim 122, wherein said plurality of carrier signals are not periodic.

125. A method as claimed in claim 123, wherein said plurality of intervals between reception of said time-stamped carrier signals provide a plurality of measurements of said local oscillator frequency in the time domain of said respective other devices.

126. A method as claimed in claim 125, wherein a time series of said intervals is indicative the phase of said local oscillator at the time of receipt of each of said decoded carrier signals.

127. A method of predicting the time of a first free-running clock at some future time in the time domain of at least one of a plurality of second clocks, comprising:
reading a data set containing a plurality of measurements of the local time of said first clock in the time domain of at least one of said plurality of second clocks;
computing a relationship between the time domain of said first clock and each of said plurality of second time domains;
extrapolating a relationship forward in time between the time domain of said first clock and at least one of said plurality of said second time domains; and
determining a local time of said first clock based at some future time, based on said relationship between said plurality of time domains.

128. A method as claimed in claim 127, including improving the determining of said local time of said first clock with statistical analysis of said plurality of relationships between said plurality of time domains.

129. A method as claimed in claim 127, wherein said extrapolation comprises a linear, polynomial, exponential extrapolation technique or combinations thereof.

130. A method as claimed in claim 127, wherein said extrapolation comprises a Kalman or G-H filtering technique.

131. A method of predicting the time of a plurality of free-running clocks at some future time in the time domain of at least one of a plurality of reference clocks, comprising:
reading a data set containing a plurality of measurements of the local time of said plurality of free-running clocks in the time domain of at least one of said plurality of reference clocks;
computing a relationship between the time domain of each of said free-running clocks and each of said plurality of reference time domains;
extrapolating a relationship forward in time between the time domain of each of said free-running clocks and at least one of said plurality of said reference time domains; and
determining a local time of each of said free-running clocks at some future time, based on the plurality of said relationships between said plurality of time domains.

132. A method as claimed in claim 131, including improving the determining of said local time of said free-running clocks by statistical analysis of said plurality of relationships between said plurality of time domains.

133. A method as claimed in claim 131, wherein said extrapolation comprises a linear, polynomial, exponential extrapolation technique or combinations thereof.

134. A method as claimed in claim 131, wherein said extrapolation comprises a Kalman or G-H filtering technique.

135. A method of controlling an event timed from a local oscillator, comprising:
receiving data indicative of a first time at which said event is to be generated in the time domain of said local oscillator;
generating a clock signal from said local oscillator;
resetting and configuring a counter/timer function with data indicative of the interval between the present time and said first time;
generating said event upon reaching a terminal count in the case of a counter function or a timeout in the case of a timer function;
clocking said counter/timer by said local oscillator.

136. A method as claimed in claim 135, wherein said clock signal is at the same frequency as and in phase with said local oscillator.

137. A method as claimed in claim 135, wherein said clock signal is a multiple of the frequency of and in phase with said local oscillator, wherein said clock signal provides greater clocking resolution than said local oscillator.

138. A method of generating a local clock signal from a local oscillator, comprising:
i) receiving data indicative of a first time at which a transition of said local clock is to be generated in the time domain of said local oscillator;
ii) generating a clock signal from said local oscillator;
iii) resetting and configuring a counter/timer function with data indicative of the interval between the present time and said first time;
iv) generating said transition of said local clock upon reaching a terminal count event in the case of a counter function or a timeout event in the case of a timer function;
v) clocking said counter/timer by said local clock; and
vi) repeating steps i) to v) upon generation of said transition of said local clock one or more times.

139. A method of synchronising data acquired by a plurality of unsynchronised devices attached to a common communication bus, comprising:
determining a mapping between unsynchronised time domains of said plurality of devices, comprising:
determining the frequency and phase of a local oscillator of each of said devices according to the method of claim 122; and
predicting the time of the local oscillator at some future time in the time domain of at least one of a plurality of second local oscillators according to the method of claim 127;
time stamping said data acquired in the time domain of each respective device;
transmitting said time stamped data to a central location; and
time aligning said data from said plurality of devices in a common time domain.

140. A method of synchronising data acquired by a plurality of unsynchronised USB devices attached to a USB, each having a free-running local oscillator, the method comprising:
said plurality of USB devices monitoring said USB traffic and decoding from said USB a plurality of time carrier signals generated by a USB host controller;
said plurality of USB devices measuring the interval between receptions of said decoded carrier signals in the time domain of said local oscillator, to provide information about the frequency of said local oscillator with respect to the known carrier signal interval; and
determining the phase of said local oscillator of each of said respective USB devices with respect to said plurality of decoded carrier signals;
said plurality of USB devices acquiring data wherein data acquisition is clocked by said respective free-running local oscillators;
time stamping said data acquired in the time domain of each respective USB device;
transmitting said time stamped data to a central location; and
time aligning said data from said plurality of devices in a common time domain.

141. A system for synchronising the local oscillator of one or more devices to a bus derived timebase, comprising:
a measurement stage adapted to characterise said local oscillators with respect to said bus derived timebase;
a prediction stage adapted to determine the evolution of time in each of said local oscillators; and
a control stage adapted to generate a synchronous clock signal local to each of said respective devices from said respective local oscillators.

142. A system as claimed in claim 141, wherein:
said measurement stage is adapted to perform the method of claim 122;
said prediction stage is adapted to perform the method of claim 127; and
said control stage is adapted to perform the method of claim 135.

143. A system as claimed in claim 142, wherein said prediction stage comprises a centrally located computing mechanism and said system is adapted to transmit data indicative of said first time to each of said devices.

144. A method of synchronising a plurality of devices, each having a local oscillator, connected via a plurality of interconnected communication busses comprising:
designating a master timing device for each bus interconnection, chosen from said plurality of devices;
said plurality of master timing devices transmitting a plurality of clock carrier signals to each of said plurality of other devices;
each of said plurality of other devices determining the frequency and phase of their respective local oscillators with respect to the time domain of said master timing device according to the method of claim 122; and
predicting the evolution of time in each of said plurality of other devices in the time domain of said master timing device according to the method of claim 127; and
synchronising said local clock of each of said plurality of devices with the notion of time of said master timing device according to the method of claim 135.
